(19) United States
(12) Patent Application Publication
(10) Pub. No.: US 2007/0283361 A1
(43) Pub. Date: Dec. 6, 2007

(54) Processor Time-Sharing Method

(76) Inventors: Jean-Bernard Blanchet, Paris (FR); Alexandre Frey, Paris (FR)

Correspondence Address: YOUNG & THOMPSON, 745 SOUTH 23RD STREET, 2ND FLOOR, ARLINGTON, VA, 22202, US

(21) Appl. No.: 11/631,511

(22) PCT Filed: Jul. 4, 2005
(86) PCT No.: PCT/FR05/01712

§ 371 Date: Mar. 15, 2007

(30) Foreign Application Priority Data
Jul. 6, 2004 (FR) 0407496

(51) Int. Cl. G06F 9/46

(52) U.S. Cl. 718/107

(57) ABSTRACT

Method for sharing the execution time of a physical processor (1) between at least two computer programs, the processor including a specific execution mode, referred to as the secure mode, having exclusive access to specific resources (3, 8, 9), and a first computer program, referred to as secure program, being executed exclusively in the secure execution mode, and a second computer program, referred to as non-secure program, being executed in an execution mode other than the secure execution mode, is characterized in that it includes the following steps: a) a periodic and regular cycle is defined for execution of the computer programs by the processor, b) the cycle is divided into two portions, one for executing the secure program, the other for executing the non-secure program.

The present invention relates to a method and a system for sharing the execution time of a single physical processor between at least two computer programs.

The security of programs has become a major concern for the industry with an ever increasing number of more and more powerful machines being networked.

This concern is not limited to “conventional” computers but also applies to mobile telephones, on-board systems etc., which include an increasing number of functions.

Operating systems are particularly vulnerable owing to their complexity. The enormous volume of code in a modern operating system makes code verification, in order to make it invulnerable, impossible.

In order to improve the security of the systems, it has been proposed to isolate the security functions from the remainder of the program.

However, this isolation cannot be purely software-based, since it could then be overcome by a malicious code executed by the non-secure portions of the operating system.

A first response has been provided by the manufacturers of microprocessors by creating a “privileged” mode which has access to more resources than the “normal” mode of the user.

During normal operation of a data-processing system, the “privileged” mode is used only by the operating system.

However, it appears that, for various reasons, and in particular for easy access to peripheral devices, increasingly significant portions of code are executed in this “privileged” mode, and therefore the problem of security auditing this code becomes difficult to resolve.

The company ARM Ltd (Cambridge, UK) proposes a new security extension for its microprocessor architecture ARMv6 which is called TrustZone (registered trade mark of ARM Ltd.).

This extension is described in a memo from this company entitled “A new Foundation for CPU Systems Security” by Richard York (May 2003) and in an article “ARM Dons Armor” by Tom R. Halfhill (Microprocessor Report/In-Stat, 25 Aug. 2003).

This extension adds a complementary special permission field to the “privileged” and “normal” modes which already exist.

In order to enter this field, the operating system must invoke a special instruction which is accessible only in “privileged” mode.

This instruction executes a context switch in order to allow access to the secure program of this field and sets a special bit to 1.

Some parts of the memory or some peripheral devices which are selected at the time at which the system is initialized, are accessible only when this special bit is set to 1. This allows the elements used by the secure program to be isolated in this manner and therefore allows malicious software executed by the non-secure operating system to be prevented from having access thereto.

In this operating mode, the secure program is the slave of the non-secure operating system since it is the operating system which calls it up. This can be a major disadvantage since malicious software which intends to take control of the machine could decide never to execute the secure program and thus prevent it from performing its functions.

Furthermore, this requires that the operating system be modified so that it takes into account the secure program. As indicated above, the operating systems are complex items of software in which it is difficult to intervene and which, in addition, are often the property of an editor who does not necessarily have the will or the desire to carry out modifications.

The object of the invention is to overcome these disadvantages.

The invention therefore relates to a method for sharing the execution time of a physical processor between at least two computer programs, the processor comprising a plurality of execution modes and having access to a plurality of resources, each of the execution modes ensuring specific access rights to the resources and, from the plurality of execution modes, at least one specific execution mode, referred to as the secure mode, having exclusive access to specific resources, and,

at least one computer program, referred to as secure program, being executed exclusively in one of the secure execution modes, and

at least one computer program, referred to as non-secure program, being executed in at least one execution mode other than the secure execution modes,

the method comprises the following steps, carried out in secure mode,

a) defining a periodic cycle for execution of the computer programs by the processor,

b) dividing this cycle into a predefined whole number of time periods, a first portion of which is allocated to the secure program and the remainder of which is allocated to the non-secure program,

the method being characterized in that it further comprises the steps involving:

c) configuring an interrupt so that it is launched at the beginning of each predefined period of the cycle,

d) calculating the execution time, in the form of a number of time periods, of the secure program during the cycle,

e) if the time period number calculated in this manner is less than the first predefined portion, then executing the secure program and otherwise executing the non-secure program.

A second aspect is a system for sharing the execution time of a physical processor between at least two computer programs, the processor comprising a plurality of execution modes and having access to a plurality of resources, each of the execution modes ensuring specific access rights to the resources and, from the plurality of execution modes, at least one specific execution mode, referred to as the secure mode, having exclusive access to specific resources, characterized in that,

at least one computer program, referred to as secure program, being executed exclusively in one of the secure execution modes, and

at least one computer program, referred to as non-secure program, being executed in at least one of the execution modes other than the secure execution mode, the system comprises:
a clock which is capable of launching an event in a regular manner, the clock being accessible in secure mode only,
means for switching context, which is referred to as a monitor, and which operates in secure mode and which allows the execution of the first computer program to be transferred to the second, and vice-versa, this context switching means being activated by the event launched by the clock, and the context switching means comprising at least a total periodic time counter and a counter for the execution time of the secure program over each period and means for comparing these counters with a predetermined value so that, if the execution time of the secure program over the period is shorter than the predetermined value, the context switching means switch the context towards executing the secure program.

Other advantages of the invention are:
the execution time of the computer program during the cycle is expressed in the form of the modulo of the sequential number of the interrupt multiplied by the number of periods of the cycle,
the interrupt is launched by a clock which is accessible in secure mode only,
an interrupt is configured so that it is launched at the end of each part of the cycle in order to transfer the execution time of the computer program which is being executed to the other computer program,
the launching is brought about by a monitoring clock which is accessible in secure mode only,
the interrupt is executed in the secure mode,
at least one of the non-secure programs is a multi-task operating system which uses a regular time interrupt for switching tasks,
if the multi-task operating system does not configure a clock for launching the regular time interrupt thereof, the interrupt for transferring one computer program to another is used in order to execute the interrupt function linked to the regular time interrupt for switching tasks,
if the multi-task operating system configures its own clock in order to launch the regular time interrupt thereof, the method further comprises the steps involving detecting the interrupts of the multi-task operating system and timing the execution of the secure program so that it is executed outside the regular time interrupts of the multi-task operating system; and
the secure program comprises a virtual machine; and
the secure program comprises an interpreted programming environment which is intended for the execution of secure or banking programs such as an STIP environment; and
the secure program comprises means for protecting the integrity of the computer programs, or for protecting the identifiers, or for protecting access to a data network, or a cryptographic service, or for controlling confidential data, or an electronic signature, or for controlling author rights, or for remote administration of a payment device.

The method and system can be used in a mobile telephone, a personal digital assistant, a bank payment terminal or a portable payment terminal.

The invention will be better understood from the following description, given purely by way of example and with reference to the appended drawings, in which:

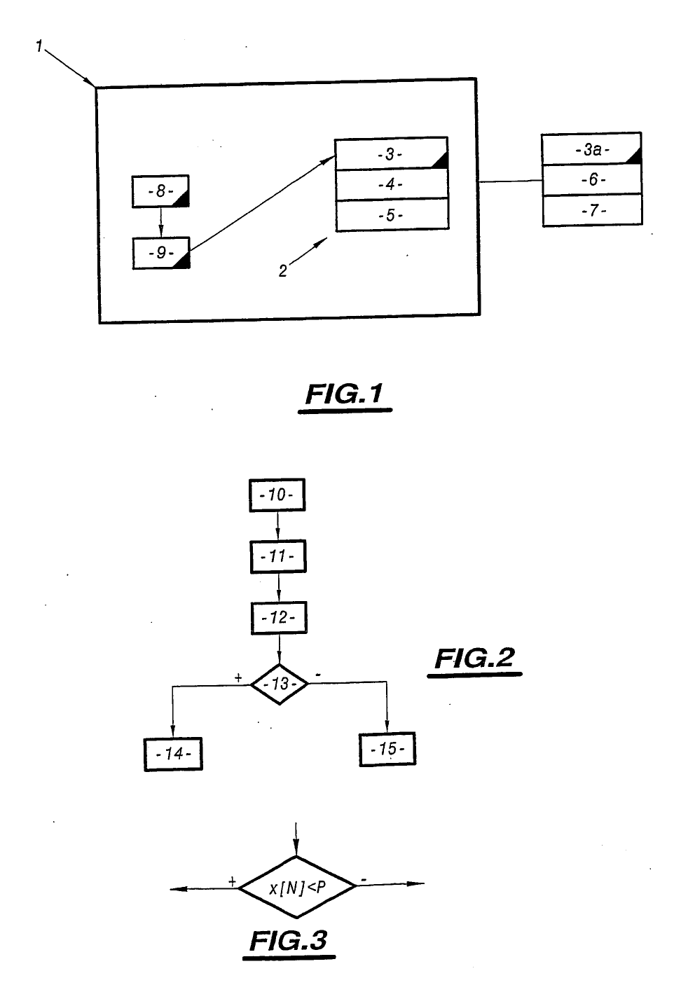

FIG. 1 is a diagram of a system comprising a processor, secure resources and non-secure resources,

FIG. 2 is a flow chart of the time control between a non-secure program and a secure program,

FIG. 3 is a flow chart of a function for calculating distribution time,

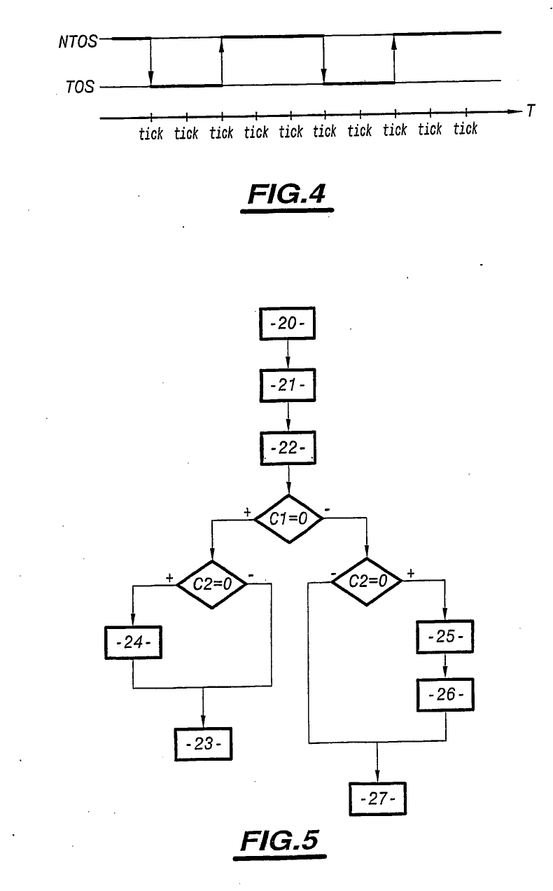

FIG. 4 is a time chart of the time distribution between a secure program and a non-secure program,

FIG. 5 is a flow chart of a second implementation of the time control between a non-secure program and a secure program, and

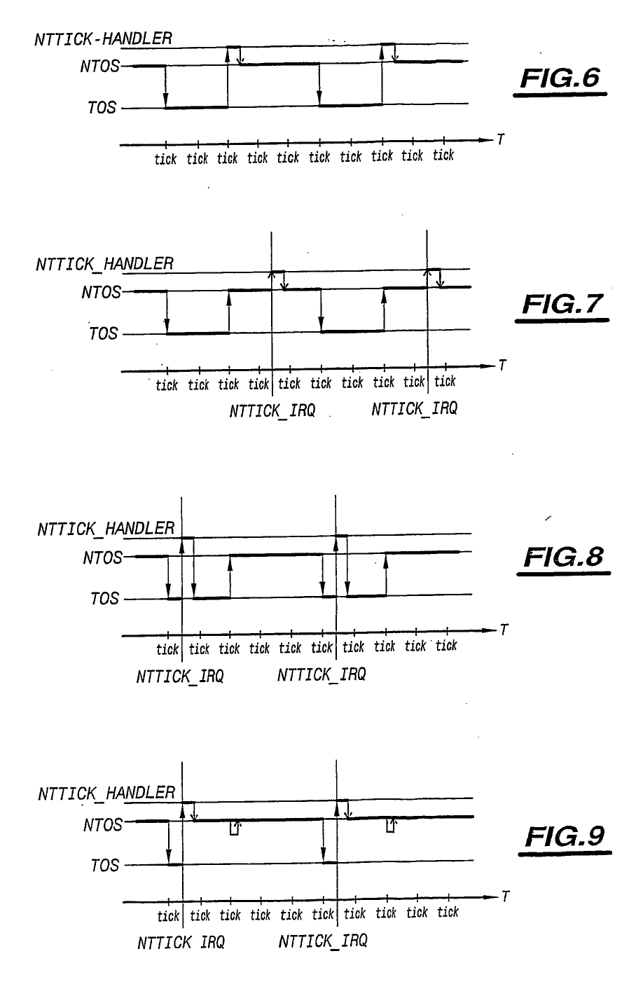

FIGS. 6, 7, 8 and 9 are time charts of the time distribution between a non-secure program and a secure program in various interrupt modes.

Although reference has been made to the security system of the company ARM, the following description is not limited to this system and the person skilled in the art will be able to readily adapt this teaching to another microprocessor architecture which has a similar security environment.

A secure environment is understood to be an environment which ensures execution of the computer program in conformity.

A processor 1 is illustrated in FIG. 1. It comprises a plurality of execution modes and various resources such as the memory 2, 2a of the arithmetical and logical units and peripheral devices.

These resources may be internal to the processor, such as the arithmetical and logical units, or external, such as specific peripheral devices or the memory.

As is well known to the person skilled in the art, each execution mode allows a specific resource to be accessed or not.

The processor 1 has a specific execution mode, referred to as the secure mode, such that specific resources are accessible only in this execution mode. These specific resources are indicated in FIG. 1 with a bottom right corner shaded in black.

In this manner, for example, the program memory 2 of the processor is divided into three zones 3, 3a, 4, 5, 6 and 7 which each correspond to a specific program. The program which resides in the secure zone 3, 3a is executed only in secure mode and only it has access to the resources 8 and 9 which are defined as secure.

For the clarity of the description and without prejudice to the generality thereof, a single computer program is assumed to operate in non-secure mode, and this computer program will be defined as non-secure.

It is thus assumed that the processor 1 has to operate a secure program using the secure memory zone 3, 3a, and a non-secure program using the non-secure memory zone 4.

The processor 1 also comprises a clock 8 which operates in secure mode and which is capable of launching an interrupt 9 at a regular and/or predetermined interval.

In order to ensure a minimum execution time for the secure program, a periodic and regular cycle is defined for execution of computer programs by the processor and the cycle is divided into two portions, one for executing the secure program and the other for executing the non-secure program.

To this end, during the initialization of the processor, the processor begins in secure mode in order to allow the whole to be initialized without risk of compromise from non-secure program.

In this manner, an environment or context is defined for the secure program and a different environment, corresponding to non-secure execution modes, is defined for the non-secure program.

The clock 8 is then configured to launch an interrupt TICK-IRQ 9 at regular intervals of a period of time TICK, this period of time being selected in order to divide the execution cycle into a whole number of time periods.

The corresponding interrupt function, referred to as TICK-HANDLER is always called up in secure mode. By way of reminder, it should be noted that an interrupt function is the function executed by the processor when the corresponding interrupt is received.

During normal operation of the processor, FIG. 2, and at the end of a time period TICK, the clock launches at 10 the interrupt TICK-IRQ which calls up at 11 the function TICK-HANDLER.

This calls up at 12 a function TRATIO-SELECTION (x) which determines the distribution of the processor time between the secure program and the non-secure program.

If this distribution is such that the secure program has benefited from less time than anticipated, the function returns a value of 1, and otherwise 0.

The value 1, at step 13, thus indicates to TICK-HANDLER that the secure program must continue to benefit from processor time at 14 if it was in the process of execution at the time of the interrupt or the context must be switched so that the secure program is executed if it was the non-secure program which was being executed at the time of the interrupt.

Conversely, the value 0, at step 13, indicates to TICK-HANDLER that it is the non-secure program which must from now on benefit, at 15, from processor time and therefore, as in the situation above, either the function returns without having done anything or it executes a context switch in accordance with the state prior to the interrupt.

As is well known to the person skilled in the art, a context switch involves saving the current context, then re-establishing the saved context which corresponds to the program to be executed.

The function TRATIO-SELECT therefore allows the processor time to be distributed between the secure program and the non-secure program, or, in other words, allows some periods to be allocated to secure program and the other periods to the non-secure program.

One possible operation, given by way of example, is the following, in FIG. 3.

Let TRATIO be the desired ratio between the time allocated to the secure program and the total execution time of the processor. TRATIO-SELECT takes at the input a whole number x which increases with each call of the function. For example, x is the chronological sequential number of the interrupt TICK-IRQ.

Two whole numbers N and P are selected so that P is less than or equal to N and the division of P by N is equal to TRATIO.

If x modulo N is strictly less than P, TRATIO-SELECT returns 1, and otherwise 0.

It should be noted that, in order to limit the number of interrupts in order to minimize the impact of these interrupts on the overall operation of the system, N and P must be selected to be as small as possible.

An example with N=5 and P=2 is given in FIG. 4 in the form of a time chart of the time distribution between the two computer programs. The line TOS represents the time of the secure program and the line NTOS the time of the non-secure program.

In the operating example set out, none of the computer programs is a pre-emptive multi-task system by time interrupt.

By way of reminder, it should be noted that a preemptive multi-task system by time interrupt uses a regular time interrupt, of a time period NTTICK, such that, with each interrupt NTTICK-IRQ, an NTTICK-HANDLER function is called whose role is to carry out a switch between the tasks.

In a second embodiment, the non-secure program is therefore a preemptive multi-task system by time interrupt.

The method is similar to that described above but the time periods TICK and NTTICK are selected so that NTTICK is a multiple of TICK. For example, NTTICK is equal to L times TICK, L being a whole number.

In this second embodiment, the non-secure program positions an interrupt vector for NTTICK-HANDLER but does not configure a clock in order to launch the interrupts NTTICK-IRQ.

The function TICK-HANDLER is used to call up the function NTTICK-HANDLER. It executes the following operations, in FIG. 5:
increasing at 20 the sequential number of the interrupt TICK-COUNT by increments of 1,
calling at 21 the function TRATIO-SELECT (TICK-COUNT) which returns C₁,
calculating at 22 TICK-COUNT modulo L, referred to as C₂. C₂ is thus equal to 0 at each time period NTTICK,
if C₁ is zero, this means that the non-secure program must be executed at 23 or continue to be executed,
if C₂ is also zero, NTTICK-HANDLER is called up at step 24, remaining in the non-secure context,
if C₁ is not zero, the secure program must be executed or must continue to be executed,
if C₂ is also zero, the function NTTICK-HANDLER is called up at 25 in the non-secure context but, on its return, the secure context is re-established at 26 and control is given at 27 to the secure program.

FIG. 6 is a time chart illustrating the operation above with TRATIO=40% and L=5.

It has been found that the limitation NTTICK=L*TICK causes NTTICK-HANDLER to be called with an interval of NTTICK as anticipated by the non-secure program.

In a third example of operation, the non-secure program is a preemptive multi-task system by time interrupt which configures a clock specific to itself in order to generate the interrupts NTTICK and thus call up the function NTTICK-HANDLER.

This interrupt may take place both during the normal operation of the non-secure program and during the operation of the secure program.

If the launch period of this clock is identical to the access period of the secure program, the interrupt is carried out with a constant delay relative to the preemption of the non-secure program by the secure program.

If the limitation NTTICK=L*TICK is always complied with, this common periodicity can be written TRATIO-SELECT(x)=TRATIO-SELECT (x modulo L).

FIG. 7 illustrates this periodicity when the interrupt NTTICK-IRQ occurs during the operation of the non-secure program.

However, this constant delay can be such that the interrupt NTTICK-IRQ occurs during the operation of the secure program. In this instance, in FIG. 8, the preemption of the secure program by the function NTTICK-HANDLER makes it necessary to move from the secure environment to the non-secure environment, then to move to the context of executing the interrupt function NTTICK-HANDLER in order to finally return to the secure environment. These operations repeated at regular intervals may bring about problems relating to performance.

Furthermore, in FIG. 9, some implementations of the multi-task preemptive operating system are such that the interrupt function NTTICK-HANDLER never returns; it carries out the task context switch of the non-secure program and proceeds directly with the execution of this new task. In this manner, in a system of this type, control is given, at the end of the interrupt, to the non-secure program and not to the secure program.

In this situation, the execution time allocated to the secure program is greatly decreased.

In order to correct this problem, it is necessary for the secure program to be able to intervene in the hardware interrupt before the interrupt function NTTICK-HANDLER is called up.

It is then sufficient to examine whether the current environment, during the interrupt, was the secure environment or the non-secure environment. If it was the secure environment, an indicator is positioned in the memory in order to indicate the problem. The function NTTICK-HANDLER is then called up normally.

The function TICK-HANDLER is modified so that the incrementation of the sequential number of the interrupt TICK-COUNT occurs only if the previous indicator is not positioned. Otherwise, the incrementation does not take place and the indicator is reset to zero.

This brings about a shift by a unit TICK for switching the non-secure environment to the secure environment, and vice-versa.

The interrupt NTTICK-IRQ is thus progressively phased in order to be launched during the execution phase of the non-secure program.

The method thus described can also be used when the secure program is a multi-task system which uses a time interrupt whose duration is regular.

In a variant of the method, the launch of the interrupts TICK-IRQ may advantageously be replaced at regular intervals by the launch of an interrupt only when the time allocated for a specific program has elapsed.

Taking the example illustrated in FIG. 4, this means that the interrogation TICK-IRQ will be launched only alternately, at every second or third TICK.

Since the method described allows the secure program to have access to the resources of the processor and, in particular, to specific interrupt vectors and the parameters of the memory protection, the non-secure program may be a standard operating system. In particular, the secure program can be executed even if the non-secure program has been designed without taking into account the presence of other environments.

It is conceivable for the secure program to be able to have different forms. It may comprise a secure virtual machine, such as a JAVA or C# virtual machine or an STIP environment (Small Terminal Interoperability Platform). The STIP environment, which specifies an environment and a dedicated virtual machine for payment terminals, typically needs to be executed in a secure environment. The STIP environment is a specific instance of an interpreted programming environment, that is to say, an environment which allows the interpreted program to be executed.

The secure program may also comprise means for protecting the integrity of the programs, or protecting the identifiers, or for protecting access to a data network, or a cryptographic service or for controlling confidential data, or an electronic signature or for controlling author rights or remote administration of a payment device.

This execution is possible owing to the interception and the manipulation of the interrupt vectors and the memory protection parameters of the program.

The method and the system described in this manner can be implemented on a number of architectures.

It is therefore conceivable to thus have a method for sharing the execution time of a physical processor 1 between at least two computer programs, the processor comprising a plurality of execution modes and having access to a plurality of resources 3, 4, 5, 6, 7, 8 and 9, each of the execution modes ensuring specific access rights to the resources and, from the plurality of execution modes, at least one specific execution mode, referred to as the secure mode, having exclusive access to specific resources 3, 8 and 9 and at least a first computer program, referred to as secure program, being executed exclusively in the secure execution mode, and

at least a second computer program, referred to as non-secure program, being executed in at least one execution mode other than the secure execution modes.

This method comprises the following steps:

a) a periodic and regular cycle is defined for execution of the program by the processor,

b) the cycle is divided into two portions, one for executing the secure program and the other for executing the non-secure program.

The periodic cycle defined in this method is divided into a predefined whole number of time periods, a first portion of which is allocated to the secure program and the remainder of which is allocated to the non-secure program.

To this end,

a) an interrupt is launched at the beginning of each predefined interval of the cycle,

b) the execution time is calculated, in the form of the number of time periods, for the secure program during the cycle,

c) if the time period number calculated in this manner is less than the first predefined portion, then the secure program is executed and otherwise the non-secure program is executed.

As indicated above, the execution time of the program during the cycle is expressed in the form of the modulo of the sequential number of the interrupt multiplied by the number of periods of the cycle.

In another embodiment, an interrupt is launched at the end of each part of the cycle in order to transfer the execution time of the program which is being executed to the other program.

In all cases, the interrupt is carried out in the secure mode. It may, for example, be launched by a clock which is accessible in secure mode only.

With regard to the non-secure program, this may be a multi-task operating system which uses a regular time interrupt for switching tasks.

If it does not configure a clock for launching the regular time interrupt thereof, the interrupt for transferring one computer program to another is used in order to execute the interrupt function linked to the regular time interrupt for switching tasks.

If, however, it configures its own clock in order to launch the regular time interrupt thereof, the method further comprises the steps involving detecting the interrupts of the multi-task operating system and timing the execution of the secure program so that it is executed outside the regular time interrupts of the multi-task operating system.

A system has also been described for sharing execution time of a physical processor between at least two computer programs, the processor comprising a plurality of execution modes and having access to a plurality of resources, each of the execution modes ensuring specific access rights to the resources and, from the plurality of execution modes, a specific execution mode, referred to as the secure mode, having exclusive access to specific resources, and a first computer program, referred to as secure program, being executed exclusively in the secure execution mode, a second computer program, referred to as non-secure program, being executed in at least one execution mode other than the secure execution mode,

which comprises:
a clock which is capable of launching an interrupt in a regular manner, the clock being accessible in secure mode only,
context switching means which operate in secure mode and which allow the execution of the first computer program to be transferred to the second, and vice-versa, these context switching means being launched by the interrupt of the clock, and the context switching means comprising at least a total periodic time counter and a counter for the execution time of the secure program over each period and means for comparing these counters with a predetermined value so that, if the execution time of the secure program over the period is shorter than the predetermined value then the context switching means switch the context towards executing the secure program.

In this manner, owing to the method and system described, it is advantageously possible to ensure an execution time for a secure program.

Furthermore, it is readily found that the operating systems or, more generally, the programs which reside in the non-secure zone do not need to be modified in order to allow this execution of secure program.

This allows the method and system described to be used in mobile telephones, personal digital assistants, portable or bank payment terminals in order to install and ensure the operation of security functions at that location.

1-16. (canceled)

17. Method for sharing the execution time of a physical processor between at least two computer programs, the processor comprising a plurality of execution modes and having access to a plurality of resources, each of the execution modes ensuring specific access rights to the resources and, from the plurality of execution modes, at least one specific execution mode, referred to as the secure mode, having exclusive access to specific resources, and,
at least one computer program, referred to as secure program, being executed exclusively in one of the secure execution modes, and
at least one computer program, referred to as non-secure program, being executed in at least one execution mode other than the secure execution modes,
the method comprises the following steps, carried out in secure mode,
a) defining a periodic cycle for execution of the computer programs by the processor,
b) dividing this cycle into a predefined whole number of time periods, a first portion of which is allocated to the secure program and the remainder of which is allocated to the non-secure program,
the method being characterized in that it further comprises the steps involving:
c) configuring an interrupt so that it is launched at the beginning of each predefined period of the cycle,
d) calculating the execution time, in the form of a number of time periods, of the secure software during the cycle,
e) if the time period number calculated in this manner is less than the first predefined portion, then executing the secure program and otherwise executing the non-secure program.

18. Method for sharing the execution time of a processor according to claim 17, characterized in that the execution time of the program during the cycle is expressed in the form of the modulo of the sequential number of the interrupt multiplied by the number of periods of the cycle.

19. Method for sharing the execution time of a processor according to claim 17, characterized in that the interrupt is launched by a clock which is accessible in secure mode only.

20. Method for sharing the execution time of a processor according to claim 17, characterized in that an interrupt is configured so that it is launched at the end of each part of the cycle in order to transfer the execution time of the program which is being executed to the other program.

21. Method for sharing the execution time of a processor according to claim 20, characterized in that the launching is brought about by a monitoring clock which is accessible in secure mode only.

22. Method for sharing the execution time of a processor according to claim 17, characterized in that the interrupt is executed in the secure mode.

23. Method for sharing the execution time of a processor according to claim 17, characterized in that at least one of the non-secure programs is a multi-task operating system which uses a regular time interrupt for switching tasks.

24. Method for sharing the execution time of a processor according to claim 23, characterized in that, if the multi-task operating system does not configure a clock for launching the regular time interrupt thereof, the interrupt for transferring one item of software to another is used in order to execute the interrupt function linked to the regular time interrupt for switching tasks.

25. Method for sharing the execution time of a processor according to claim 23, characterized in that, if the multi-task operating system configures its own clock in order to launch the regular time interrupt thereof, the method further comprises the steps involving detecting the interrupts of the multi-task operating system and timing the execution of the secure program so that it is executed outside the regular time interrupts of the multi-task operating system.

26. Method for sharing the execution time of a processor according to claim 17, characterized in that the secure program comprises a virtual machine.

27. Method for sharing the execution time of a processor according to claim 26, characterized in that the secure program comprises an interpreted programming environment which is intended for the execution of secure or banking programs such as an STIP environment.

28. System for sharing the execution time of a physical processor between at least two computer programs, the processor comprising a plurality of execution modes and having access to a plurality of resources, each of the execution modes ensuring specific access rights to the resources and, from the plurality of execution modes, at least one specific execution mode, referred to as the secure mode, having exclusive access to specific resources, characterized in that, at least one computer program, referred to as secure program, being executed exclusively in one of the secure execution modes, and
at least one computer program, referred to as non-secure program, being executed in at least one of the execution modes other than the secure execution mode,
the system comprises:
a clock which is capable of launching an event in a regular manner, the clock being accessible in secure mode only,
means for switching context, which is referred to as a monitor and which operates in secure mode and which allows the execution of the first computer program to be transferred to the second, and vice-versa, this context switching means being activated by the event launched by the clock,
and the context switching means comprising at least a total periodic time counter and a counter for the execution time of the secure program over each period and means for comparing these counters with a predetermined value so that, if the execution time of the secure program over the period is shorter than the predetermined value, the context switching means switches the context towards executing the secure program.

29. System for sharing the execution time of a physical processor between at least two computer programs according to claim 28, characterized in that the secure program comprises a virtual machine.

30. System for sharing the execution time of a physical processor between at least two computer programs according to claim 29, characterized in that the secure program comprises an interpreted programming environment which is intended for the execution of secure or banking programs such as an STIP environment.

31. System for sharing the execution time of a physical processor between at least two computer programs according to claim 28, characterized in that the secure program comprises means for protecting the integrity of the program, or for protecting the identifiers, or for protecting access to a data network, or a cryptographic service, or for controlling confidential data, or an electronic signature, or for controlling author rights, or for remote administration of a payment device.

32. Method for sharing the execution time of a processor according to claim 18, characterized in that the interrupt is launched by a clock which is accessible in secure mode only.
